(19) United States
(12) Patent Application Publication
(10) Pub. No.: US 2006/0049979 A1
(43) Pub. Date: Mar. 9, 2006

(54) Device for transmitting and receiving radar radiation

(76) Inventors: Klaus-Dieter Miosga, Backnang (DE); Armin Himmelstoss, Weissach Im Tal (DE); Guenter Bertsch, Stuttgart (DE); Joachim Hauk, Renningen-Malmsheim (DE)

Correspondence Address: KENYON & KENYON, ONE BROADWAY, NEW YORK, NY, 10004, US

(21) Appl. No.: 10/514,676

(22) PCT Filed: Dec. 16, 2002
(86) PCT No.: PCT/DE02/04586

§ 371 Date: Jun. 28, 2005

(30) Foreign Application Priority Data
May 24, 2002 (DE) 102 23 124.9

(51) Int. Cl. G01S 7/28

(52) U.S. Cl. 342/175; 342/70; 342/71

(57) ABSTRACT

In a device for transmitting and receiving radar radiation, at least one patch antenna is provided as transmit and receive element, which is directly connected to at least one mixing element.

### FIELD OF THE INVENTION

The present invention relates to a device for transmitting and receiving radar radiation in which at least one patch antenna is provided as transmit and receive element, this antenna being directly connected to at least one mixing element.

### BACKGROUND INFORMATION

From European Patent Application No. EP 0685930 a radar transmitter and receiver system is known in which the microwave output of a frequency-modulated oscillator is transmitted to a transmitter antenna and a mixer input, and the microwave output, which was reflected by the target and received by the antenna, is transmitted to a second mixer input. In this system, the separation of the transmit and receive signals is performed via two ring cable couplers, which are connected to one another by means of two connecting lines.

### SUMMARY OF THE INVENTION

An essence of the present invention is to provide a device for transmitting and receiving radar radiation, which has simple structures, is easy to manufacture, has low manufacturing cost and high phase noise correlation suppression.

It is advantageous that the transmitter and receiver element, which is designed as at least one patch antenna, is directly connected to at least one mixing element, the at least one mixing element being connected to the center of the patch antenna. In this case, the center of the patch antenna is the center point of the geometrical arrangement, with 1=(n+1)*λ/2 for n=1, 2, 3, [symbol] , as which the patch antenna is designed.

Furthermore, it is advantageous that one mixing element in each case is arranged at two opposite-lying edges of the patch antenna. If the patch antenna has a rectangular form, it is advantageous to arrange the two mixing elements at two opposite-lying edges of the rectangle. If the patch antenna is configured as circle or ellipsis, it is advantageous to arrange the mixing elements at two edge points of the antenna, in such a way that they are diametrically opposed.

Moreover, it is advantageous that 2n patch antennas with n=0, 1, 2, [symbol] are advantageously provided as transmit and receive elements, these 2n patch antennas being arranged in particular approximately on a common straight line and the 2n patch antennas being connected to the transmitter oscillator by means of symmetrical 2 dB power splitters. This makes it possible to evenly distribute the output of the transmitter oscillator to all patch antennas, using the least complicated means, without this causing losses in the output of the transmitter oscillator.

Furthermore, it is advantageous that the mixing elements are diodes. Configuring the mixing elements in the form of mixer diodes results in an inexpensive realization, which is easy to produce and has a compact design as far as the spatial dimensions are concerned.

Furthermore it is advantageous that the dimensions of the device for transmitting and receiving microwave radiation are designed for the frequency range between 75 and 80 GHz.

In addition, it is advantageous that the device for transmitting and receiving radar radiation is used for adaptive distance and speed control in a vehicle radar system. A system for adaptive distance and speed control in a motor vehicle measures the distance as well as the relative speed of objects traveling ahead and implements a speed control in the sense of a speed constant regulation or a distance constant regulation as a function thereof.

### BRIEF DESCRIPTION OF THE DRAWINGS

FIG. 1 shows a possible implementation of the device for transmitting and receiving radar radiation.

FIG. 2 shows a detailed view of a first specific embodiment of the device.

FIG. 3 shows a detailed view of a second specific embodiment.

FIG. 4 shows a cross-sectional view of the detailed view of a second specific embodiment.

FIG. 5 shows a detailed view of a third specific embodiment.

FIG. 6 shows a cross-sectional view of the detailed view of a third specific embodiment.

### DETAILED DESCRIPTION

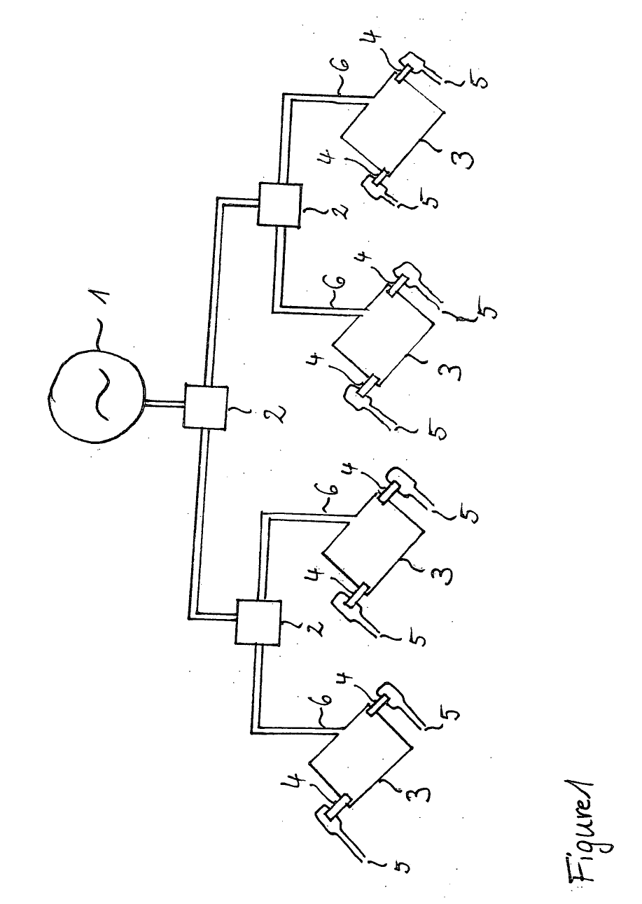

FIG. 1 shows a preferred exemplary embodiment of a device for transmitting and receiving radar radiation, which, by way of example, includes four patch antennas in this case. Shown is a transmitting oscillator 1, which provides a transmission signal that advantageously is in the range of approximately 77 GHz and which in an advantageous manner may be modulated as frequency modulated continuous wave (FMCW) or as pulse signal. This transmission output provided by transmitting oscillator 1 is distributed to a plurality of antenna feeder lines 6 via several 3 dB-power splitters. The number of patch antennas, which are advantageously situated approximately on a common straight line, are advantageously selected such that they are able to be supplied via 3 dB-power splitters without any losses occurring in the process. This means that the number of patch antennas is advantageously selected to be 1, 2, 4, 8, [symbol] , which may also be written as 2n with n=0, 1, 2, [symbol] Transmission power feed lines 6 lead into patch antennas 3, which are shown as rectangular antenna patches in FIG. 1 and have been tilted in such a way in this example that a diagonal polarization of the emitted wave is produced. The emitted radar wave is reflected at objects in the detection range of the radar system and reflected back in the direction of transmit and receive antennas 3.

Patch antennas 3, which operate both as transmit and receive antennas, receive the reflected radar radiation. The received electrical signal is mixed with the instantaneously arriving transmit signal on antenna patch 3 and demodulated with the aid of mixing elements 4, which are embodied as mixer diodes 4 in this case. It is therefore possible to directly pick off the demodulated intermediate frequency signal at diode outputs 5. According to this embodiment, the particular mixer is combined with the particular antenna patch so as to produce the shortest possible paths and to minimize a phase noise caused by different path lengths of the transmit and receive signals. Furthermore, as a result of this arrangement, which requires no ring coupler, sufficient electrical power is available at mixing elements 4, which are advantageously configured as mixing diodes 4, to be able to dispense with a bias voltage of the mixing elements by means of a d.c. voltage.

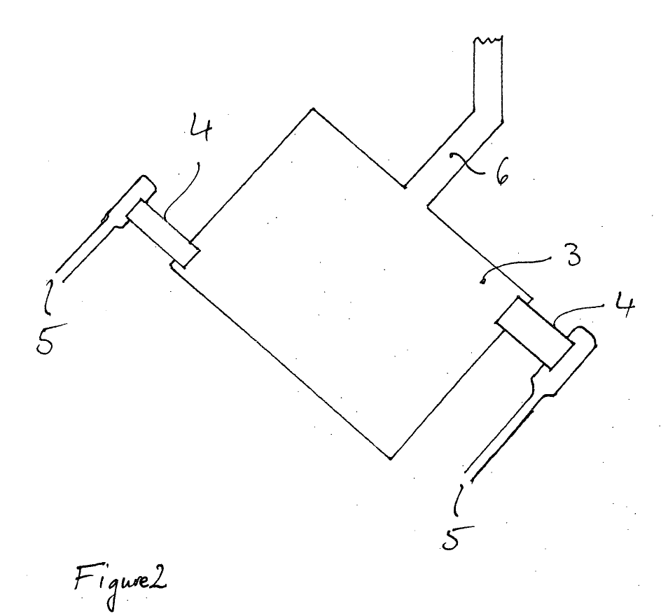

FIG. 2 shows a detailed view of a patch antenna according to the present invention. The figure shows transmit feeder line 6 via which transmitting oscillator 1 supplies the patch antenna with the required transmission power. Antenna patch 3, which is used as receive and transmit antenna, has two mixing elements 4 at two opposite-lying edges of the antenna patch, which may be embodied as mixer diodes, for example. Both the transmit signal and the electrical receive signal received by the antenna are superimposed at these mixing elements 4 and demodulated due to the non-linearity of mixer diode 4. As a result, a demodulated intermediate frequency signal is able to be picked off at output 5, which may be forwarded to a device for further processing. By way of example, this is at least one analog-digital converter and a device for further processing in the form of a computing device, which may be configured as microcontroller or signal processor, for instance.

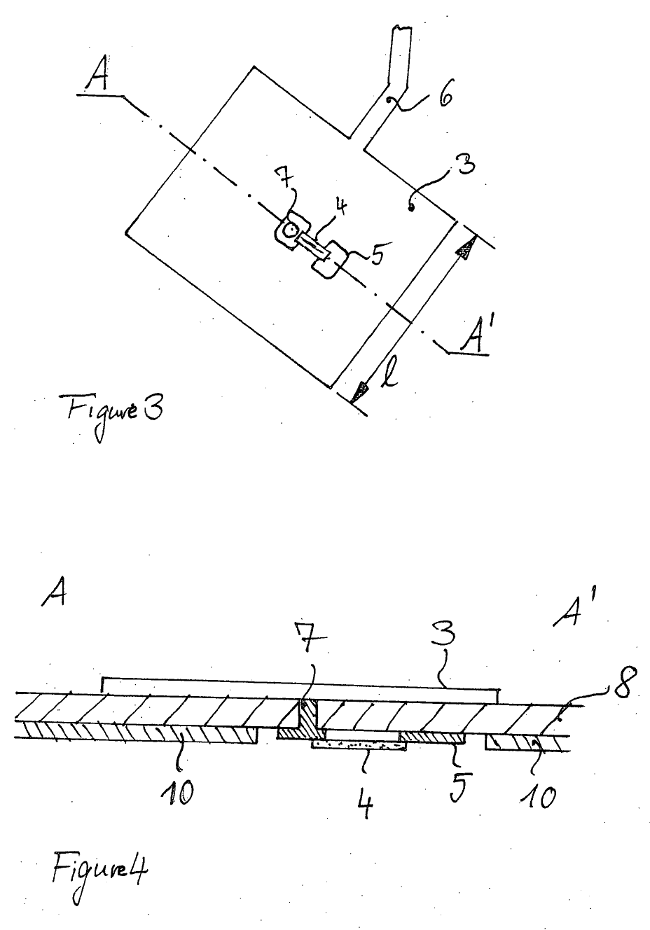

Another variant of an embodiment, which once again includes transmit feeder line 6 as well as antenna patch 3, is shown in FIG. 3. The transmission output of transmitting oscillator 1 is supplied to the antenna via transmit feeder line 6 and radiated by antenna 3. The transmission wave reflected at objects in the detection range of the radar system is received by antenna 3 as receive wave and converted into an electrical signal. In this exemplary embodiment, a mixing element 4, which once again may be embodied as mixer diode, is connected in the center of the antenna patch for mixing and demodulation. To this end, a conductive feed-through through the substrate on which patch antenna 3 is applied may be provided in the center of antenna patch 3, and required mixing element 4 be affixed to the underside of the substrate. In FIG. 3, a section A-A′ is provided for this purpose whose sectional view will be explained in greater detail in FIG. 4.

FIG. 4 shows a sectional view of the variant of the embodiment according to FIG. 3 along line A-A′. As before, patch antenna 3 is shown, which is applied on a substrate 8 and may be embodied as printed circuit board or as ceramic, for instance. A feed-through 7 is provided in the center of patch antenna 3 in substrate 8, so that mixing element 4 is able to be connected to patch antenna 3 on the underside of substrate 8. In this case, the direct connection of mixing elements 4 with patch antenna 3 refers to the direct electrical connection of these two elements. In addition, an earth surface 10 is provided on the underside of substrate 8, the earth surface covering the region around mixing element 4 and intermediate frequency output 5.

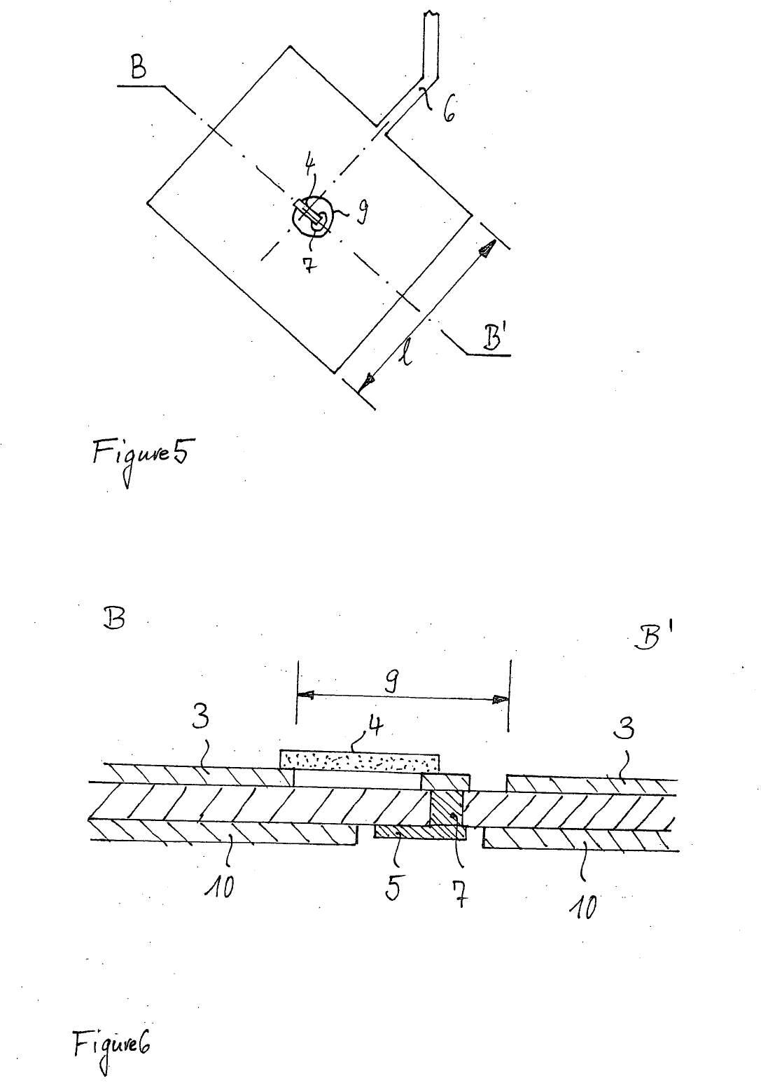

FIG. 5 shows an additional specific embodiment of the device according to the present invention in which mixing element 4 is provided on the same side of substrate 8 as patch antenna 3. To this end, the center of patch antenna 3 includes a recess in which feed-through 7 through the substrate is situated. Mixing element 4 then establishes an electrical connection between patch antenna 3 and feed-through 7, so that the intermediate frequency signal may be tapped off directly on the underside of the substrate.

FIG. 6 shows a sectional view along line B-B′ of the variant of an embodiment according to FIG. 5. Shown once again are substrate 8, patch antenna 3, which has recess 9 in the region of feed-through 7 along line B-B′, as well as mixing element 4, which connects patch antenna 3 to feed-through 7. The demodulated intermediate frequency signal may be picked off on the underside of substrate 8 at conductive layer 5 for further processing. In addition, an earth surface 10 is provided on the underside of substrate 8, which covers the region around feed-through 7 and intermediate frequency output 5.

1-7. (canceled)

8. A device for transmitting and receiving radar radiation, the device comprising:
at least one mixing element; and
at least one patch antenna provided as a transmit and receive element, the at least one patch antenna being directly connected to the at least one mixing element.

9. The device according to claim 8, wherein the at least one mixing element is connected to a center of the patch antenna.

10. The device according to claim 8, wherein each one of the at least one mixing element is connected to the patch antenna at two opposite-lying edges.

11. The device according to claim 8, further comprising a transmitting oscillator and symmetrical 3 dB power splitters, and wherein the at least one patch antenna includes 2n patch antennas connected to the transmitting oscillator via the power splitters, wherein n=0, 1, 2, . . .

12. The device according to claim 8, wherein the at least one mixing element includes diodes.

13. The device according to claim 8, wherein the device is for transmitting and receiving microwave radiation and is dimensioned to a range of about 77 GHz.

14. The device according to claim 8, wherein the device is used in a motor vehicle radar system for adaptive distance and speed regulation.
